(19) United States
(12) Patent Application Publication
(10) Pub. No.: US 2009/0231524 A1
(43) Pub. Date: Sep. 17, 2009

(54) DISPLAY DEVICE, DISPLAY DEVICE MANUFACTURING METHOD, SUBSTRATE, AND COLOR FILTER SUBSTRATE

(76) Inventor: Mitsuhiro Tanaka, Mie (JP)

Correspondence Address: BIRCH STEWART KOLASCH & BIRCH, PO BOX 747, FALLS CHURCH, VA, 22040-0747, US

(21) Appl. No.: 12/090,622

(22) PCT Filed: Aug. 11, 2006
(86) PCT No.: PCT/JP2006/315928

§ 371 Date: Apr. 17, 2008

(30) Foreign Application Priority Data
Jan. 24, 2006 (JP) 2006-015066

(51) Int. Cl. G02F 1/1339; G02F 1/1333

(52) U.S. Cl. 349/110; 349/153; 349/190

(57) ABSTRACT

[Means for Solving the Problems] The outer periphery of a display medium layer is sealed by a sealant made of UV curable resin provided between first and second substrates. In the first substrate, a light shielding part including a light shielding layer is provided at a part corresponding to the sealant. In the second substrate, a part corresponding to the sealant is transparent. The light shielding part includes a face on the sealant side serving as a UV ray reflection face.

### TECHNICAL FIELD

The present invention relates to a display device, a display device manufacturing method, a substrate, and a color filter substrate.

### BACKGROUND ART

In liquid crystal display panels in which liquid crystal is sealed between two substrates including electrodes, a sealant is used for bonding the two substrates. As a material of the sealant, thermosetting epoxy resin has been known conventionally.

The sealant of which main component is the thermosetting epoxy resin, however, lowers in its viscosity in the initial stage of heating in a step of heat-curing the sealant after bonding the substrates. For this reason, the alignment accuracy of substrates lowers and gap deficiency caused due to line discontinuity or a dry spot of the sealant is caused. Further, it takes about one hour to heat-cure the sealant, thereby involving lowering of the production efficiency. In addition, upsizing of the mother substrate accompanies upsizing of the heat-curing facility.

As a countermeasure for solving the above problems, there has been known a UV curable sealant between the substrates which is made of radically polymerized methacryl, acryl resin, or the like.

A method of manufacturing a liquid crystal display panel using a UV curable sealant will be described herein. First, an alignment film made of polyimide resin is formed on a substrate including a pair of electrodes, and the alignment of the liquid crystal is determined by rubbing. A UV curable sealant is applied, by screen printing and rendering using a dispenser, onto the substrate subjected to alignment film treatment to form a predetermined pattern. Spacers are then arranged on the opposed substrate for forming a gap between the substrates. Next, a necessary amount of a liquid crystal material is dropped and supplied onto a region surrounded by the sealant to bond the substrates to each other. Thereafter, a UV ray is irradiated to only a region sealed by the sealant for curing the sealant with the sealed region light-shielded. The bonded substrates thus manufactured suppresses lowering of alignment accuracy of the substrates and gap deficiency caused due to line discontinuity and a dry spot of the sealant, when compared with that using a sealant of which main component is thermosetting epoxy resin. Further, time required for curing can be shortened to increase the production efficiency. In addition, upsizing of the mother substrate requires no upsizing of the UV curing facility.

In a case using the UV curable sealant as above, however, the sealed region must be irradiated with the UV ray. This requires the sealant to be formed around the outer peripheral part of the light shielding layer. In recent years, the panel frame edge is required to be narrower and narrower, which accompanies research and development of substrate bonding by providing the sealant on the light shielding layer. In such substrate bonding by providing the sealant on the light shielding layer, however, the light shielding layer intercepts the irradiated UV ray to inhibit the UV ray from reaching the entire sealant, thereby leaving a part of the sealant uncured. Further, for narrowing the frame edge of a panel using a TFT substrate including a driver at its light shielding part, it is difficult for the UV ray to reach the entire sealant because of the presence of the driver, thereby leaving a part of the sealant uncured, as well.

In order to solve the above problems, Patent Document 1 discloses a liquid crystal display panel manufacturing method including the steps of: forming a UV curing sealant for bonding two opposed substrates to each other and for sealing liquid crystal; bonding the two substrates after aligning a substrate on which the sealant is formed to an opposed substrate; pressing the bonded substrates to have a predetermined gap; irradiating the sealant with a UV ray under adjustment of the temperature of the substrates in the range between 40° C. and 80° C., both inclusive, with a part other than the sealed part light-shielded; and forming a liquid crystal cell by dividing the substrates with a necessary terminal part left. According to this method, the sealant of a color reflective type liquid crystal panel can be UV-cured easily.

### Patent Document 1: Japanese Unexamined Patent Application Publication 2002-202514

### SUMMARY OF THE INVENTION

### Problems that the Invention is to Solve

In the technique according to the Patent Document 1, however, the UV ray reaches deficiently in a part shaded by wirings formed in the light shielding part to lower the polymerization of the sealant. When an uncured part remains in this way, a problem rises in the reliability of the liquid crystal display panel.

Further, in one drop filling in which a liquid crystal material is dropped onto one of the substrates for obtaining the bonded substrates, it is necessary to transfer the liquid crystal material after bonding the substrates. If an uncured part remains in the sealed region, the sealant is melted into the liquid crystal material in transferring the liquid crystal material, namely, at temperature rise of the substrates, thereby involving lowering of the display quality and lowering of the reliability of the liquid crystal display panel.

### Means for Solving the Problems

One object of the present invention is to provide a display device, a display device manufacturing method, a substrate, and a color filter substrate which facilitate UV curing of a sealant.

A display device in accordance with the present invention includes: first and second substrates opposed to each other and a display medium layer interposed therebetween, wherein the display medium layer has an outer peripheral part sealed by a sealant of UV curable resin provided between the first and second substrates, the first substrate includes a light shielding part including a light shielding layer provided at a part corresponding to the sealant while the second substrate includes a transparent part provided at a part corresponding to the sealant, and the light shielding part has a UV ray reflection face on a sealant side thereof.

In the above arrangement, in the display device provided with the sealant made of the UV curable resin formed in the light shielding part in which the light shielding layer is provided, the first substrate and the second substrate are bonded to each other by UV ray irradiation. To do so, the sealant is irradiated with the UV ray from the transparent sealant corresponding part of the second substrate for curing the sealant, wherein the UV ray irradiated from the second substrate side is reflected by the UV reflection face formed on the light shielding part of the first substrate to the sealant to irradiate the sealant again. Accordingly, even if a wiring of Al or the like is formed on the substrate to inhibit the UV ray from reaching the sealant, the UV ray is irradiated to the sealant again from the UV ray reflection face to cure an uncured part of the sealant. Thus, ordinary UV ray irradiation cures the sealant further effectively and easily.

In the display device in accordance with the present invention, the UV ray reflection face may be made of Al or Ag.

With the above arrangement, Al or Ag of the UV ray reflection face increases the reflectivity of the UV ray reflection face, thereby achieving further efficient and easy UV ray reflection to cure the sealant.

Further, in the display device in accordance with the present invention, the UV ray reflection face may be so composed to receive a UV ray and reflect the UV ray outward of the display medium layer.

With the above arrangement, entering of the UV ray reflected by the UV ray reflection face into the display medium layer is suppressed. Accordingly, adverse influence on display quality, which is caused due to influence of the UV ray on the display medium, can be suppressed.

The display device in accordance with the present invention may further include UV ray scattering means scattering a UV ray reflected by the UV ray reflection face.

With the above arrangement, the TV ray reflected by the UV ray reflection face is scattered by the UV ray scattering means to attain more effective irradiation of a part of the sealant which is light-shielded and remains uncured with the UV ray. Thus, the entire region of the sealant can be cured effectively and easily.

In the display device in accordance with the present invention, the UV ray scattering means may be a bumpy part formed in the light shielding part, wherein the UV ray reflection face is formed on the bumpy part.

In the above arrangement, the UV ray scattering means is the bumpy part formed in the light shielding part and the UV ray reflection face is formed on the bumpy part. Accordingly, the UV ray reaching the UV ray reflection face is scattered correspondingly to the bumpy part upon reflection. Thus, the entire region of the sealant can be cured further effectively and easily.

In the display device in accordance with the present invention, the bumpy part may be the light shielding layer of the light shielding part.

With the above arrangement, formation of the light shielding layer of the light shielding part as the bumpy part eliminates the need to prepare another member for forming the bumpy part. In other words, only required is to form the light shielding layer so as to have the bumpy part. Accordingly, the UV ray scattering means can be formed efficiently.

Furthermore, in the display device in accordance with the present invention, the UV ray scattering means may be composed of UV ray scattering particles contained in the sealant.

In the above arrangement, the UV ray scattering particles are contained in the sealant in advance to enable provision of the UV ray scattering means by supplying the sealant to the substrate at the same time. Accordingly, the manufacturing efficiency increases. Further, when the sealant contains the UV ray scattering particles, the UV ray scattering means spreads uniformly in the sealant, thereby attaining further effective scattering of the UV ray.

In the display device in accordance with the present invention, the UV ray scattering particles may have a refractivity different from the sealant.

In the above arrangement, the UV ray scattering particles have a refractivity different from the sealant, so that the UV ray is refracted at the interface between the sealant and the UV ray scattering particles, thereby being scattered effectively over the entire sealant.

Furthermore, in the display device in accordance with the present invention, the UV ray scattering particles may reflect a UV ray.

In the above arrangement, the UV ray scattering particles reflects the UV ray, and accordingly, the UV ray is scattered by the UV ray scattering particles effectively over the entire sealant.

In the display device in accordance with the present invention, the UV ray reflection face and the UV ray scattering means may be formed in this order on the light shielding layer.

In the above arrangement, the UV ray reflection face and the UV ray scattering means are provided in this order on the light shielding layer. Accordingly, the UV ray is reflected by the UV ray reflection face and then is scattered by the UV ray scattering means. This allows the UV ray to reach the entire sealant thoroughly, thereby curing the sealant effectively.

In the display device in accordance with the present invention, the UV ray scattering means may be a UV ray scattering resin layer.

In the above arrangement, the UV ray scattering means is the UV ray scattering resin layer, and therefore, the UV ray scattering means can be formed into a desired shape easily. Accordingly, the UV ray can be scattered easily in the entire sealant or a desired part selectively.

Still further, in the display device in accordance with the present invention, the UV ray scattering means may be a bumpy layer having a refractivity different from that of the sealant.

In the above arrangement, the UV ray scattering means is the bumpy layer having a refractivity different from that of the sealant. Accordingly, the reflected UV ray is refracted at the interface between the sealant and the bumpy layer to reach the entire sealant thoroughly, thereby curing the sealant effectively.

In the display device in accordance with the present invention, the UV ray scattering means may be a layer formed of a plurality of lenses.

In the above arrangement, the UV ray scattering means is a layer formed of a plurality of lenses, which means attainment of the UV ray scattering means having a simple structure.

In the display device in accordance with the present invention, a spacer may be provided between the first and second substrates, wherein the spacer is made of the same material as the UV ray scattering means.

In the above arrangement, the spacer made of the same material as that of the UV ray scattering means is provided between the first and second substrates. This enables formation of the spacer and the UV ray scattering means with the use of the same material in the same step, thereby increasing the production efficiency of the device.

In the display device in accordance with the present invention, the display part may include a display element covered with an overcoat layer, wherein the overcoat layer is made of the same material as the UV ray scattering means.

In the above arrangement, the display element of the display part is covered with the overcoat layer made of the same material as that of the UV ray scattering means. Accordingly, the overcoat layer and the UV ray scattering means can be formed with the use of the same material in the same step, thereby increasing the production efficiency of the device.

In addition, in the display device in accordance with the present invention, the display part may be composed of a light reflection region provided with a step layer for restricting a gap between the first substrate and the second substrate and a light transmission region, wherein the step layer formed in the light reflection region is made of the same material as the UV ray scattering means.

In the above arrangement, the display part is formed of the light transmitting region and the light reflection region in which the step layer is formed for restricting the gap between the first substrate and the second substrate, and the step layer formed in the light reflection region is made of the same material as the UV ray scattering means. Accordingly, the step layer formed in the light reflection region and the UV ray scattering means can be formed with the use of the same material in the same step, thereby increasing the production efficiency of the device.

A display device manufacturing method in accordance with the present invention is a method including the steps of: preparing a first and second substrates each including a display cell formation part; forming a light shielding layer on the first substrate so as to surround and enclose the display cell formation part of the first substrate; providing a UV ray reflection face on the light shielding layer formed on the first substrate; providing a sealant at a light shielding part formation part of the first or second substrate without forming a cut; supplying a display medium to the display cell formation part of the first or second substrate to which the sealant is provided; bonding the first or second substrate to which the display medium is supplied to the other substrate; and obtaining bonded substrates by curing the sealant by irradiating the sealant with a UV ray from the surface of the bonded second substrate.

According to the above arrangement, for manufacturing a display device in which the sealant made of the UV curable resin is formed in the light shielding part in which the light shielding layer is provided, the first substrate and the second substrate are bonded to each other by curing the sealant by UV ray irradiation. In the UV ray irradiation, the UV ray irradiated from the second substrate side is reflected to the sealant by the UV ray reflection face formed in the light shielding part of the first substrate, thereby being irradiated to the sealant again. Accordingly, even if a wiring of Al or the like is formed on the substrate to inhibit the UV ray from reaching the sealant, the sealant is irradiated again with the UV ray from the UV ray reflection face, thereby curing an uncured part of the sealant. Thus, ordinary UV ray irradiation cures the sealant further effectively and easily.

A color filter substrate in accordance with the present invention includes: a transparent substrate including a display part; a light shielding layer provided along an outer periphery of the display part of the transparent substrate and forming a light shielding part; and a UV ray reflection face provided on the light shielding layer on the transparent substrate.

With the above arrangement, the following advantages can be attained in a display device in which the sealant made of the UV curable resin is formed in the light shielding part in which the light shielding layer is provided. Namely: for bonding the color filter substrate and the TFT substrate to each other by UV ray irradiation, the UV ray is irradiated at the part of the TFT substrate which corresponds to the sealant to cure the sealant; the UV ray irradiated from the TFT substrate side is reflected to the sealant by the UV ray reflection face formed in the light shielding part of the color filter substrate to thus irradiate the sealant again. Accordingly, even if a wiring of Al or the like is formed on the TFT substrate to inhibit the UV ray from reaching the sealant, the sealant is irradiated again with the UV ray from the UV ray reflection face, thereby curing an uncured part of the sealant. Thus, ordinary UV ray irradiation cures the sealant further effectively and easily.

### EFFECTS OF THE INVENTION

As described above, the present invention can provide a display device, a display device manufacturing method, a substrate, and a color filter substrate which facilitate UV curing of a sealant.

### BRIEF DESCRIPTION OF THE DRAWINGS

FIG. 1 is a sectional view of a liquid crystal display device 10 and a color filter substrate in accordance with Embodiment 1 of the present invention.

FIG. 2 is a sectional view of a liquid crystal display device 20 and a color filter substrate in accordance with Embodiment 2 of the present invention.

FIG. 3 is a sectional view of a liquid crystal display device 30 and a color filter substrate in accordance with Embodiment 3 of the present invention.

FIG. 4 is a sectional view of a liquid crystal display device 40 and a color filter substrate in accordance with Embodiment 4 of the present invention.

FIG. 5 is a sectional view of a liquid crystal display device 50 and a color filter substrate in accordance with Embodiment 5 of the present invention.

FIG. 6 is a sectional view of a liquid crystal display device 60 and a color filter substrate in accordance with Embodiment 6 of the present invention.

FIG. 7 is a sectional view of a liquid crystal display device 70 and a color filter substrate in accordance with Embodiment 7 of the present invention.

FIG. 8 is a sectional view of a liquid crystal display device 80 and a color filter substrate in accordance with Embodiment 8 of the present invention.

FIG. 9 is a sectional view of a liquid crystal display device 90 and a color filter substrate in accordance with Embodiment 9 of the present invention.

FIG. 10 is a sectional view of a liquid crystal display device 100 and a color filter substrate in accordance with Embodiment 10 of the present invention.

FIG. 11 is a diagram showing a step of preparing a TFT substrate 12 in a method for manufacturing any of the liquid crystal display devices 10 to 100 in accordance with Embodiments 1 to 10 of the present invention.

FIG. 12 is a diagram showing a step of applying a sealant 113 in the method for manufacturing any of the liquid crystal display devices 10 to 100 in accordance with Embodiments 1 to 10 of the present invention.

FIG. 13 is a diagram showing a step of dropping a liquid crystal material 114 in the method for manufacturing any of the liquid crystal display devices 10 to 100 in accordance with Embodiments 1 to 10 of the present invention.

FIG. 14 is a diagram showing a step of bonding substrates in the method for manufacturing any of the liquid crystal display devices 10 to 100 in accordance with Embodiments 1 to 10 of the present invention.

FIG. 15 is a diagram showing a step of irradiating a UV ray in the method for manufacturing any of the liquid crystal display devices 10 to 100 in accordance with Embodiments 1 to 10 of the present invention.

FIG. 16 is a diagram showing a step of performing heating and heat removal in the method for manufacturing any of the liquid crystal display devices 10 to 100 in accordance with Embodiments 1 to 10 of the present invention.

### EXPLANATION OF REFERENCE NUMERALS

10, 20, 30, 40, 50, 60, 70, 80, 90, 100 liquid crystal display device
11, 21, 31, 41, 51, 61, 71, 81, 91, 101 CF substrate
12 TFT substrate
13 liquid crystal layer
14, 24, 34, 44, 54, 64, 74, 84, 94, 104 liquid crystal display panel
15, 111 glass substrate
16 color layer
17 black matrix
18, 28 UV ray scattering underlying layer
19 UV ray reflection film
48 particles having different refractivity
58 particles reflecting UV ray
68, 88, 98, 108 UV ray scattering resin layer
78 microlens layer
110 UV ray reflection face
112 wiring
113 sealant
114 liquid crystal material
120 column-shaped spacer
130 overcoat layer
140 step layer
150 UV ray

### BEST MODE FOR CARRYING OUT THE INVENTION

A color filter substrate, a display device using it, and a display device manufacturing method in accordance with embodiments of the present invention will be described below in detail with reference to the accompanying drawings. It is noted that the present invention is not limited to the following embodiments. A liquid crystal display device will be referred to herein as the display device.

### Embodiment 1

(Constructions of color filter substrate 11 and liquid crystal display device 10 using it)

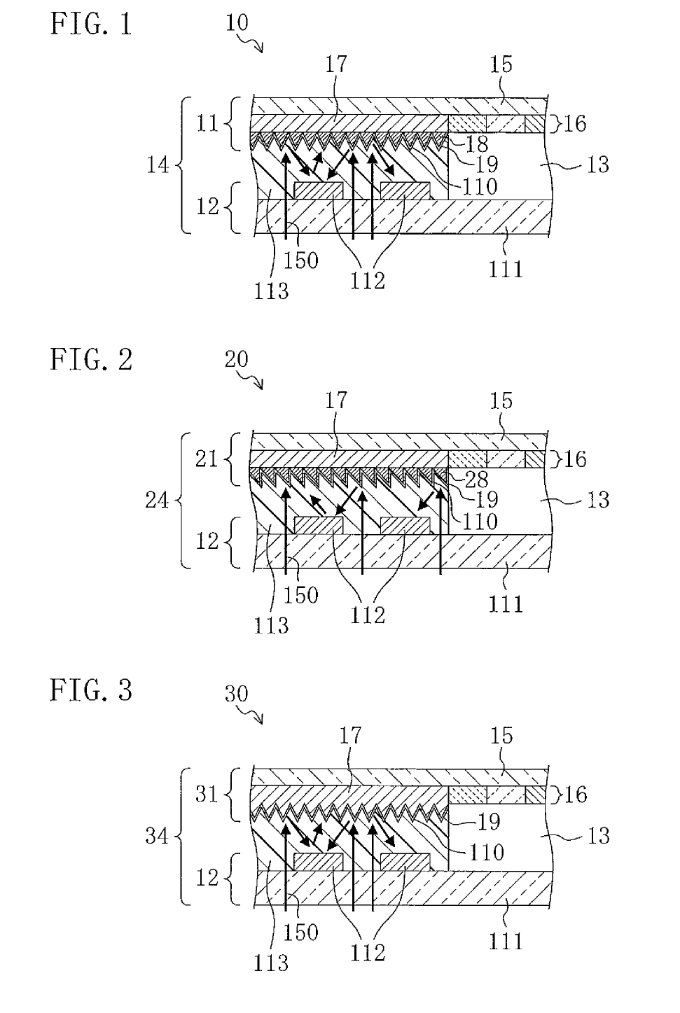

FIG. 1 is a sectional view of a liquid crystal display device 10. The liquid crystal display device 10 includes a liquid crystal display panel 14, a backlight unit (not shown), and the like, wherein the liquid display panel 14 includes a color filter substrate 11 and a thin film transistor substrate 12 which are opposed to each other, a liquid crystal layer 13 (display medium layer) provided therebetween, and column shaped spacers (not shown) provided between the opposed substrates.

In the color filter substrate (CF substrate 11), a color layer 16 of three primary colors of red (R), green (G), and blue (B) is formed on a glass substrate 15 to form a display part. The color layer 16 may include complementary colors of cyan, magenta, and yellow in addition to the combination of RGB.

A counter electrode and an alignment film (both not shown) are formed on the color layer 16. A black matrix 17 (a light shielding layer) as a fringe for contrast is provided around the outer periphery of the color layer 16 to form a light shielding part. A UV ray scattering underlying layer 18 (UV ray scattering means) is formed on the black matrix 17.

The UV ray scattering underlying layer 18 is made of a resin material, a ceramic material, or the like and has a bumpy surface forming a bumpy part. The bumpy surface may be in any shape. For example, the bumpy part may be formed of a plurality of protrusions in a semispherical shape, a conical shape, a pyramid shape, a column shape, or the like. Alternatively, continuous corrugation may be formed all over the entirety thereof. A UV ray reflection film 19 covers the surface of the UV ray scattering underlying layer 18 to form a UV ray reflection face 110.

The UV ray reflection film 19 is made of metal having high reflectivity, such as Al, Ag, or the like, or an alloy thereof. For lowering the reflectivity on the observer's side, metal having low reflectivity, such as Cr or the like may be provided between the UV ray reflection film 19 and the UV ray scattering underlying film 18. As well, an adhesion layer made of SiO₂ or the like may be provided between the UV ray reflection film 19 and the UV ray scattering underlying layer 18. In addition, a protection layer, a reflection increasing film, or the like of SiO₂ or the like may be formed on the UV ray reflection film 19.

The thin film transistor substrate (TFT substrate 12) includes a glass substrate 111, TFT elements (not shown) of gate electrodes, source electrodes, drain electrodes, and the like formed on the glass substrate 111, a transparent insulating layer, pixel electrodes, an alignment film, and the like (each not shown). Among wirings for electrically connecting the TFT elements, a wiring 112 made of Al or the like is provided in the light shielding part for narrowing the frame of the display device.

A sealant 113 is provided between the UV ray reflection film 19 on the black matrix 17 of the CF 11 substrate and the opposed TFT substrate 12 so as to bond the substrates to each other. The sealant 113 has no liquid crystal sealing port and is arranged continuously with no cut formed so as to surround the display part, thereby forming a liquid crystal display cell. The sealant 113 is made of a UV curable adhesive of racially polymerized methacryl, acryl resin, or the like.

(Method for Manufacturing Liquid Crystal Display Device 10)

A method for manufacturing the liquid crystal display device 10 in accordance with Embodiment 1 will be described next in detail.

(Process of Manufacturing CF Substrate 11)

First, the glass substrate 15 is prepared. A region of the glass substrate 15 which is to be the light shielding part is sputtered to form the black matrix 17 having a width of 100 mm or smaller at the frame part thereof and a width of 5 to 50 μm between the pixels thereof. Then, a resin film (a dry film) in which red pigment is dispersed is laminated on the entirety of a region of the glass substrate 15 which is to be the display part, and exposure, development, and baking (heat treatment) are performed to form a first color layer (red). Next, a resin film in which green pigment is dispersed is laminated on the entire first color layer, and exposure, development, and baking (heat treatment) are performed to form a second color layer (green). A third color layer (blue) is formed by the same manner.

As an alternative method for forming the color layer 16 rather than lamination of the dry films, photosensitive resin materials in which pigments are dispersed may be applied to the entirety thereof by spin coating or slit coating. The order of forming the color layers of the colors is not limited specifically, and another order may be employed.

Next, ITO is deposited on the color layer 16 to form the counter electrode, and then, the alignment film is formed.

Subsequently, a thin film layer is formed on the black matrix 17, and a die having a surface formed of multiple fine protrusions and depressions is pressed thereto so that the surface of the thin film layer is in a bumpy shape, thereby forming the UV ray scattering underlying layer 18. After formation of the UV ray scattering underlying layer 18, a metal thin film of Al or the like as the UV ray reflection film 19 is formed so as to cover the surface of the UV ray scattering underlying layer 18.

Through the above steps, the CF substrate 11 is completed.

As an alternative process of forming the UV ray scattering underlying layer 18, a thin film layer layered on a temporal support member having a surface formed of multiple fine protrusions and depressions may be transferred to the black matrix 17. The temporal support member having a bumpy surface for forming the transfer film capable of scattering light may be manufactured by molding by a die of which surface has multiple fine protrusions and depressions. Alternatively, an undercoat layer capable of being modified into a base film may be provided, wherein a die of which surface has multiple fine protrusions and depressions is pressed to the undercoat layer and the undercoat layer is cured to become a film as the base film. Or, a base film of which surface is subjected to sand blasting may be used.

As one example of preparation of the die or the temporal support member of which surface has the multiple fine protrusions and depressions, the following may be employed. Namely, a photoresist is applied on an insulating plate; exposure and development are performed with the use of a photomask having a predetermined mask pattern or laser cutting is performed; a silver or nickel film is formed (conduction treatment) on the pattern forming face by vacuum deposition, sputtering, or the like; nickel is layered by electrocasting; and then the layers are exfoliated from the insulating plate to thus form a father die. Next, the father die is subjected to exfoliation, nickel electrocasting again, and exfoliation, thereby forming a mother die. Then, the multiple fine protrusions and depressions are formed by the thus formed mother die, thereby forming the die or the support member.

(Process of Manufacturing TFT Substrate 12)

Subsequently, the glass substrate 111 is prepared, and the gate electrodes made of Ta or Al/Ti are formed by sputtering and are patterned. Then, a gate insulating film of SiNx and a thin film of semiconductor a-Si or p-Si or single-crystal Si are formed. Next, an etching protection film of SiNx is formed and pattern formation is performed. Contact holes, the drain electrodes, and the source electrodes are formed then. A driver is provide at the end part of the substrate in the same or another step to thus form thin film transistors. The transparent insulating layer is formed in a predetermined region. Thereafter, ITO is vacuum-deposited and pattern formation is performed to form the pixel electrodes. Next, a plurality of column-shaped spacers for defining the cell thickness are formed by photolithography. The column-shaped spacers may be formed on the CF substrate 11. Further, spherical spacers may be formed by spraying instead.

Through the above steps, the TFT substrate 12 is manufactured.

(Process of Forming Liquid Crystal Display Panel 14)

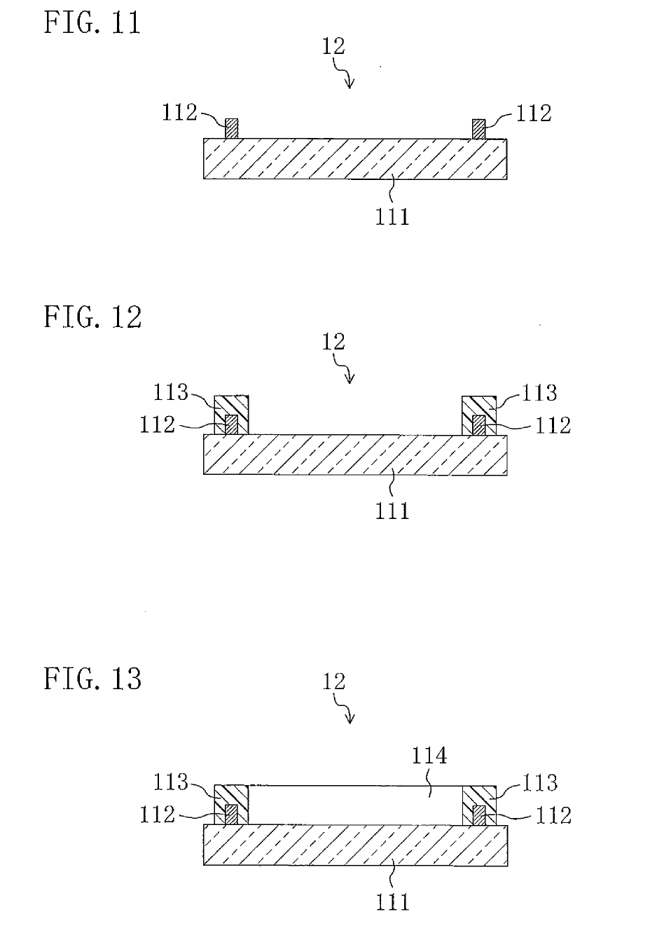

A process of forming the liquid crystal display panel 14 will be described next with reference to FIG. 11 to FIG. 16.

First, as shown in FIG. 12, the sealant 113 is applied continuously without forming a cut onto the light shielding part of the TFT substrate 12 shown in FIG. 11 in which the wiring 112 of Al or the like is formed.

Next, as shown in FIG. 13, the liquid crystal material 114 is dropped at 2 mg per one shot, for example, onto the TFT substrate 12 with the use of a dispenser or the like. The liquid crystal material 114 is dropped within the frame-shaped sealant 113 applied around the outer periphery of the light shielding part of the TFT substrate 12.

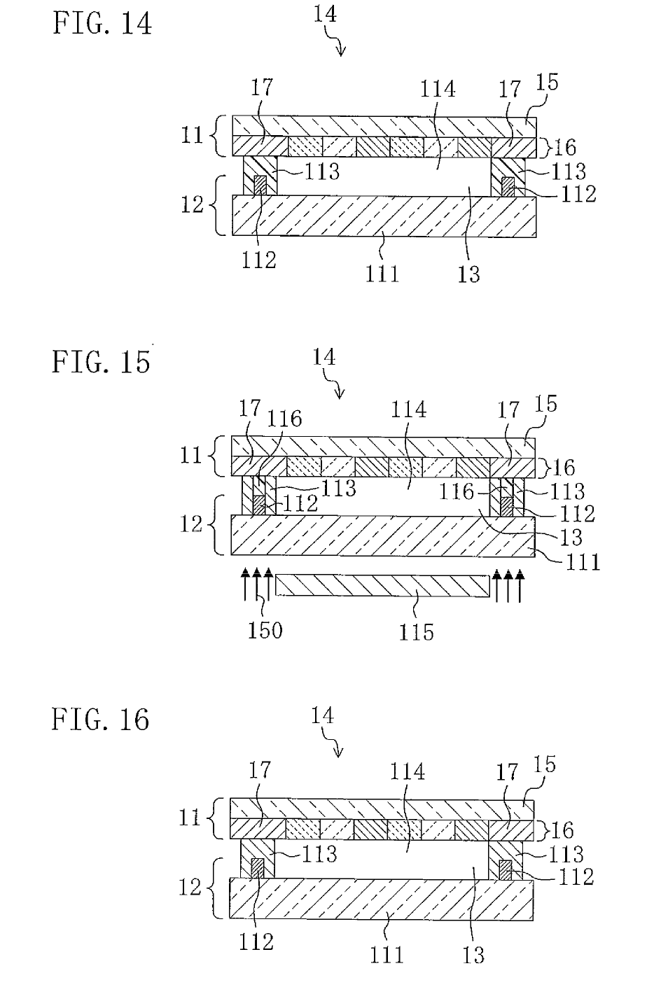

Subsequently, as shown in FIG. 14, the CF substrate 11 is aligned and bonded to the TFT substrate 12 on which the liquid crystal material 114 is dropped. Whereby, the liquid crystal display cell is formed in the region surrounded by the sealant 113 between the CF substrate 11 and the TFT substrate 12 bonded to each other. This step is performed under a vacuum state. Then, the substrates are returned to the air so that the liquid crystal material 114 between the TFT substrate 12 and the CF substrate 11 bonded to each other is dispersed by the air pressure.

Thereafter, as shown in FIG. 15, a UV ray 150 is irradiated from the TFT substrate 12 side with a light shielding mask 115 formed on the display part of the TFT substrate 12. The irradiated UV ray 150 enters from a part of the TFT substrate 12 which corresponds to the sealant to cure the sealant 113. With the wiring 112 of Al or the like formed in the light shielding part of the TFT substrate 12, the UV ray 150 is intercepted by the wiring 112 to leave an uncured region 116 in the sealant 113. The UV ray 150 reaching the sealant 113, however, advances straight and reaches the UV ray reflection face 110 formed in the light shielding part of the CF substrate 11. The UV ray reflection face 110 is formed on the bumpy surface of the UV ray scattering underlying layer 18, and therefore, the UV ray 150 reaching the UV ray reflection face 110 is reflected and scattered correspondingly to the bumpy shape.

The thus scattered and reflected UV ray 150 is irradiated again to the sealant 113 and is reflected also by the wiring 112 of Al or the like formed on the TFT substrate 12 so as to be irradiated all over a wide range of the sealant 113. Accordingly, the uncured region 116 of the sealant 113 is cured by the reflected UV ray.

Next, as shown in FIG. 16, the light shielding mask 115 is removed, heating and heat removal are performed, and then, the substrates are cut into a desired panel frame.

In this way, the liquid crystal display panel 14 is formed in which the liquid crystal material 114 is sealed by the cured sealant 113 between the two substrates. Then, the back light unit and the like (not shown) are provided thereto to complete the liquid crystal display device 10.

### Embodiment 2

(Constructions of Color Filter Substrate 21 and Liquid Crystal Display Device 20 Using it)

FIG. 2 is a sectional view of a liquid crystal display device 20 in accordance with Embodiment 2. The same reference numerals are assigned to the same parts as those indicated in the above embodiment for omitting description thereof.

The liquid crystal display device 20 includes a liquid crystal display panel 24, the back light, and the like (not shown), wherein the liquid crystal display panel 24 includes the TFT substrate 12 and a CF substrate 21 opposed to each other and the liquid crystal layer 13 between the substrates.

In the CF substrate 21, the color layer 16 composing the display part and the counter electrode and the alignment film (both not shown) are formed on the glass substrate 15. The black matrix 17 is provided around the outer periphery of the color layer 16 to form the light shielding part. The UV ray scattering underlying layer 28 is formed on the black matrix 17.

The UV ray scattering underlying layer 28 is made of a resin material, a ceramic material, or the like and has a bumpy surface. The bumpy shape of the surface is formed of faces perpendicular to a display part formation region (a region where the liquid crystal layer 13 is formed) of the CF substrate 21 and inclined faces opposite to the region. The bumpy shape of the CF substrate 21 may be any shape only if it can reflect the received UV ray outward of the liquid crystal layer 13. The UV ray scattering underlying layer 28 is covered at the surface thereof with the UV ray reflection film 19.

The sealant 113 is provided between the UV ray reflection film 19 on the black matrix 17 of the CF substrate 21 and the opposed TFT substrate 12 to bond the substrates to each other. The sealant 113 has no liquid crystal sealing port and is arranged continuously with no cut formed so as to surround the display part, thereby forming the liquid crystal display cell.

(Method for Manufacturing Liquid Crystal Display Device 20)

A method for manufacturing the liquid crystal display device 20 in accordance with Embodiment 2 will be described next. Description of the same parts as those indicated in the above embodiment is omitted.

(Process of Manufacturing CF Substrate 21)

First, as in Embodiment 1, the color layer 16, the black matrix 17, the counter electrode, and the alignment film are formed on the glass substrate 15.

Next, the thin film layer is formed on the black matrix 17, and a die having a bumpy surface composed of multiple fine vertical and inclined faces is pressed to the thin film layer to allow the thin film layer to have the bumpy surface, thereby forming the UV ray scattering underlying layer 28. After formation of the UV ray scattering underlying layer 28, a metal thin film made of Al or the like as the UV ray reflection film 19 is formed so as to cover the surface of the UV ray scattering underlying layer 28.

Through the steps, the CF substrate 21 is completed.

(Process of Manufacturing TFT Substrate 12)

Subsequently, the TFT substrate 12 is formed by the same manner as in Embodiment 1.

(Process of Forming Liquid Crystal Display Panel 24)

Thereafter, the sealant 113 is applied continuously without forming a cut onto the light shielding part of the TFT substrate 12 in which the wiring 112 is formed.

Next, the liquid crystal material 114 is dropped within the frame-shaped sealant 113 applied around the outer periphery of the light shielding part of the TFT substrate 12 with the use of a dispenser or the like.

Subsequently, the CF substrate 21 is aligned and joined to the TFT substrate 12 on which the liquid crystal material 114 is dropped. This step is performed under a vacuum state. Then, the substrates are returned to the air so that the liquid crystal material 114 is dispersed by the air pressure.

Thereafter, the UV ray 150 is irradiated from the TFT substrate 12 side with the light shielding mask 115 formed on the display part of the TFT substrate 12. The irradiated UV ray 150 enters from a part of the TFT substrate 12 which corresponds to the sealant to cure the sealant 113. With the wiring 112 of Al or the like formed in the light shielding part of the TFT substrate 12, the UV ray 150 is intercepted by the wiring to leave an uncured region 116 in the sealant 113. The UV ray 150 reaching the sealant 113, however, advances straight and reaches the UV ray reflection face 110 formed in the light shielding part of the CF substrate 21. The UV ray reflection face 110 is formed on the bumpy surface of the UV ray scattering underlying layer 18, and therefore, the UV ray 150 reaching the UV ray reflection face 110 is reflected and scattered correspondingly to the bumpy shape.

The thus scattered and reflected UV ray 150 is irradiated again to the sealant 113 and is reflected also by the wiring 112 of Al or the like formed on the TFT substrate 12 so as to be irradiated all over a wide range of the sealant 113. Accordingly, the uncured region 116 of the sealant 113 is cured by the reflected UV ray. Since the bumpy surface of the UV ray scattering underlying layer 28 is composed of the vertical faces and the inclined faces, the UV ray 150 received at the surface (the UV ray reflection face 110) of the UV ray reflection film 19 formed thereon is reflected outward of the liquid crystal layer 13. Accordingly, the reflected UV ray does not advance toward the liquid crystal layer 13 and is not irradiated to the liquid crystal layer 13.

Next, the light shielding mask 115 is removed, heating and heat removal are performed, and then, the substrates are divided into a desired panel frame.

In this way, the liquid crystal display panel 24 is formed in which the liquid crystal material 114 is sealed by the cured sealant 113 between the two substrates. Then, the back light unit and the like (not shown) are provided thereto to complete the liquid crystal display device 20.

### Embodiment 3

(Constructions of Color Filter Substrate and Liquid Crystal Display Device 20 Using it)

FIG. 3 is a sectional view of a liquid crystal device 30 in accordance with Embodiment 3. The same reference numerals are assigned to the same parts as those indicated in the above embodiment for omitting description thereof.

The liquid crystal display device 30 includes a liquid crystal display panel 34, the back light (not shown), and the like, wherein the liquid crystal display panel 34 includes the TFT substrate 12 and a CF substrate 31 opposed to each other and the liquid crystal layer 13 between the substrates.

In the CF substrate 31, the color layer 16 composing the display part and the counter electrode and the alignment film (both not shown) are formed on the glass substrate 15. The black matrix 17 is provided around the outer periphery of the color layer 16 to form the light shielding part.

The black matrix 17 has a surface formed in a bumpy shape serving as UV ray scattering means. The bumpy surface of the black matrix 17 may have any shape. As the bumpy shape, a plurality of protrusions in a semispherical shape, a conical shape, a pyramid shape, a column shape, or the like may be formed, or gentle corrugation may be formed all over the entirety thereof, for example. The black matrix 17 is covered at the surface thereof with the UV ray reflection film 19

The TFT substrate 12 includes the glass substrate 111, the TFT elements (not shown) of the gate electrodes, the source electrodes, the drain electrodes, and the like formed on the glass substrate 111, the transparent insulating layer, the pixel electrodes, the alignment film (each not shown), and the like.

The sealant 113 is provided between the UV ray reflection film 19 on the black matrix 17 of the CF substrate 31 and the opposed TFT substrate 12 so as to bond the substrates to each other. The sealant 113 has no liquid crystal sealing port and is arranged continuously with no cut formed so as to surround the display part, thereby forming the liquid crystal display cell.

(Method for Manufacturing Liquid Crystal Display Device 30)

A method for manufacturing the liquid crystal display device 30 in accordance with Embodiment 3 will be described next. Description of the same parts as those indicated in the above embodiment is omitted.

(Process of Manufacturing CF Substrate 31)

First, as in Embodiment 1, the color layer 6, the black matrix 7, the counter electrode, and the alignment film are formed on the glass substrate 15

Next, the black matrix 17 is subjected to treatment, such as etching to have the bumpy surface. Then, a metal thin film of Al or the like as the UV ray reflection film 19 is formed so as to cover the surface of the black matrix 17.

Through the above steps, the CF substrate 31 is completed.

(Process of Manufacturing TFT Substrate 12)

Subsequently, the TFT substrate 12 is formed by the same manner as in Embodiment 1.

(Process of Forming Liquid Crystal Display Panel 34)

Thereafter, the sealant 113 is applied continuously without forming a cut onto the light shielding part of the TFT substrate 12 in which the wiring 112 is formed.

Next, the liquid crystal material 114 is dropped within the frame-shaped sealant 113 applied around the outer periphery of the light shielding part of the TFT substrate 12 with the use of a dispenser or the like.

Subsequently, the CF substrate 31 is aligned and joined to the TFT substrate 12 on which the liquid crystal material 114 is dropped. This step is performed under a vacuum state. Then, the substrates are returned to the air so that the liquid crystal material 114 is dispersed by the air pressure.

Thereafter, the UV ray 150 is irradiated from the TFT substrate 12 side with the light shielding mask 115 formed on the display part of the TFT substrate 12. The irradiated UV ray 150 enters from a part of the TFT substrate 12 which corresponds to the sealant to cure the sealant 113. With the wiring 112 of Al or the like formed in the light shielding part of the TFT substrate 12, the UV ray 150 is intercepted by the wiring 112 to leave an uncured region 116 in the sealant 113. The UV ray 150 reaching the sealant 113, however, advances straight and reaches the UV ray reflection face 110 formed in the light shielding part of the CF substrate 31. The UV ray reflection face 110 is formed on the bumpy surface of the black matrix 17, and therefore, the UV ray 150 reaching the UV ray reflection face 110 is reflected and scattered correspondingly to the bumpy shape.

The thus scattered and reflected UV ray 150 is irradiated again to the sealant 113 and is reflected also by the wiring 112 of Al or the like formed on the TFT substrate 12 so as to be irradiated all over a wide range of the sealant 113. Accordingly, the uncured region 116 of the sealant 113 is cured by the reflected UV ray.

Next, the light shielding mask 115 is removed, heating and heat removal are performed, and then, the substrates are cut into a desired panel frame.

In this way, the liquid crystal display panel 34 is formed in which the liquid crystal material 114 is sealed by the sealant 113 between the two substrates. Then, the back light unit and the like (not shown) are provided thereto to complete the liquid crystal display device 30.

### Embodiment 4

(Constructions of Color Filter Substrate 41 and Liquid Crystal Display Device 40 Using it)

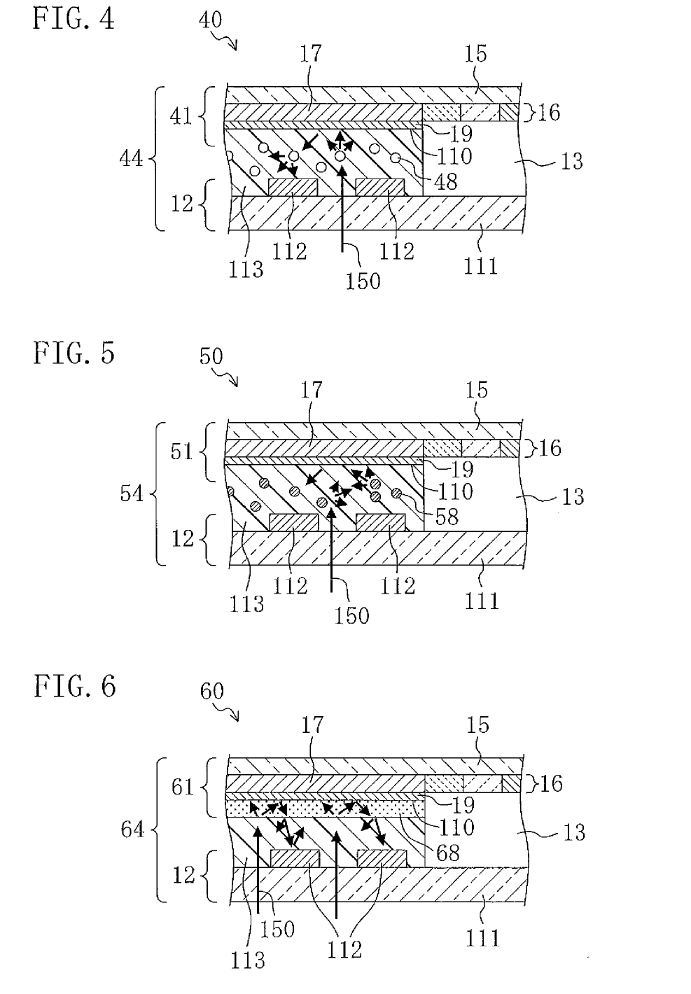

FIG. 4 is a sectional view of a liquid crystal display device 40 in accordance with Embodiment 4. The same reference numerals are assigned to the same parts as those indicated in the above embodiment for omitting description thereof.

The liquid crystal display device 40 includes a liquid crystal display panel 44, the back light, and the like (not shown), wherein the liquid crystal display panel 44 includes the TFT substrate 12 and a CF substrate 41 opposed to each other and the liquid crystal layer 13 between the substrates.

In the CF substrate 41, the color layer 16 composing the display part and the counter electrode and the alignment film (both not shown) are formed on the glass substrate 15. The black matrix 17 is provided around the outer periphery of the color layer 16 to form the light shielding part. The UV ray reflection film 19 is formed on the black matrix 17.

The sealant 113 is provided between the UV ray reflection film 19 on the black matrix 17 of the CF substrate 41 and the opposed TFT substrate 12 so as to bond the substrates to each other. The sealant 113 has no liquid crystal sealing port and is arranged continuously with no cut formed so as to surround the display part, thereby forming the liquid crystal display cell. The sealant 113 contains particles 48 (UV scattering particles) of 0.01 to 1 weight part per 100 weight parts having different refractivity. The particles 48 having the different refractivity means particles of which refractivity is 0.03 or larger different from that of the sealant 113, for example, and has a mean grain diameter of for example, 1 to 5 μm, which involves no influence on the cell thickness.

(Method for Manufacturing Liquid Crystal Display Device 40)

A method for manufacturing the liquid crystal display device 40 in accordance with Embodiment 4 will be described next. Description of the same parts as those indicated in the above embodiment is omitted.

(Process of Manufacturing CF Substrate 41)

First, as in Embodiment 1, the color layer 16, the black matrix 17, the counter electrode, and the alignment film are formed on the glass substrate 15.

Next, the UV ray reflection film 19 is formed on the black matrix 17.

Through the above steps, the CF substrate 41 is completed.

(Process of Manufacturing TFT Substrate 12)

Subsequently, the TFT substrate 12 is formed by the same manner as in Embodiment 1.

(Process of Forming Liquid Crystal Display Panel 44)

Thereafter, the sealant 113 is applied continuously without forming a cut onto the light shielding part of the TFT substrate 12 in which the wiring 112 is formed.

Next, the liquid crystal material 114 is dropped within the frame-shaped sealant 113 applied around the outer periphery of the light shielding part of the TFT substrate 12 with the use of a dispenser or the like.

Subsequently, the CF substrate 41 is aligned and joined to the TFT substrate 12 on which the liquid crystal material 114 is dropped. This step is performed under a vacuum state. Then, the substrates are returned to the air so that the liquid crystal material 114 is dispersed by the air pressure.

Thereafter, the UV ray 150 is irradiated from the TFT substrate 12 side with the light shielding mask 115 formed on the display part of the TFT substrate 12. The irradiated UV ray 150 enters from a part of the TFT substrate 12 which corresponds to the sealant to cure the sealant 113. With the wiring 112 of Al or the like formed in the light shielding part of the TFT substrate 12, the UV ray 150 is intercepted by the wiring 112 to leave an uncured region 116 in the sealant 113. The UV ray 150 reaching the sealant 113, however, advances straight and reaches the UV ray reflection face 110 formed in the light shielding part of the CF substrate 41 to be irradiated to the sealant 113 again.

Wherein, the sealant 113 contains the particles 48 having the different refractivity, so that the UV ray 150 is reflected at the interface between the sealant 113 and the particles 48 having the different refractivity to be scattered in a wide range. The thus scattered UV ray 150 is irradiated to the sealant 113 again and is reflected by the wiring 112 of Al or the like formed on the TFT substrate 12 to be irradiated all over a wide range of the sealant 113. Accordingly, the uncured region 116 of the sealant 113 is cured by the reflected UV ray.

Next, the light shielding mask 115 is removed, heating and heat removal are performed, and then, the substrates are cut into a desired panel frame.

In this way, the liquid crystal display panel 44 is formed in which the liquid crystal material 114 is sealed by the sealant 113 between the two substrates. Then, the back light unit and the like (not shown) are provided thereto to complete the liquid crystal display device 40.

### Embodiment 5

(Constructions of Color Filter Substrate 51 and Liquid Crystal Display Device 50 Using it)

FIG. 5 is a sectional view of a liquid crystal display device 50 in accordance with Embodiment 5. The same reference numerals are assigned to the same parts as those indicated in the above embodiment for omitting description thereof.

The liquid crystal display device 50 includes a liquid crystal display panel 54, the back light, and the like (not shown), wherein the liquid display pane 54 includes the TFT substrate 12 and a CF substrate 51 opposed to each other and the liquid crystal layer 13 between the substrates.

In the CF substrate 51, the color layer 16 composing the display part and the counter electrode and the alignment film (both not shown) are formed on the glass substrate 15. The black matrix 17 is provided around the outer periphery of the color layer 16 to form the light shielding part. The UV ray reflection film 19 is formed on the black matrix 17.

The sealant 113 is provided between the UV ray reflection film 19 on the black matrix 17 of the CF substrate and the opposed TFT substrate 12 so as to bond the substrates to each other. The sealant 113 has no liquid crystal sealing port and is arranged continuously with no cut formed so as to surround the display part, thereby forming the liquid crystal display cell. The sealant 113 contains particles 58 (UV ray scattering particles) of 0.01 to 1 weight part per 100 weight parts reflecting a UV ray. The particles 58 reflecting the UV ray means particles having a surface subjected to mirror finishing, for example, and has a mean grain diameter of, for example, 1 to 5 μm, which involves no influence on the cell thickness.

(Method for Manufacturing Liquid Crystal Display Device 50)

A method for manufacturing the liquid crystal display device 50 in accordance with Embodiment 5 will be described next. Description of the same parts as those indicated in the above embodiment is omitted.

(Process of Manufacturing CF Substrate 51)

First, as in Embodiment 1, the color layer 16, the black matrix 17, the counter electrode, and the alignment film are formed on the glass substrate 15.

Next, the UV ray reflection film 19 is formed on the black matrix 17.

Through the above steps, the CF substrate 51 is completed.

(Process of Manufacturing TFT Substrate 12)

Subsequently, the TFT substrate 12 is formed by the same manner as in Embodiment 1.

(Process of Forming Liquid Crystal Display Panel 54)

Thereafter, the sealant 113 is applied continuously without forming a cut onto the light shielding part of the TFT substrate 12 in which the wiring 112 is formed.

Next, the liquid crystal material 114 is dropped within the frame-shaped sealant 113 applied around the outer periphery of the light shielding part of the TFT substrate 12 with the use of a dispenser or the like.

Subsequently, the CF substrate 51 is aligned and joined to the TFT substrate 12 on which the liquid crystal material 114 is dropped. This step is performed under a vacuum state. Then, the substrates are returned to the air so that the liquid crystal material 114 is dispersed by the air pressure.

Thereafter, the UV ray 150 is irradiated from the TFT substrate 12 side with the light shielding mask 115 formed on the display part of the TFT substrate 12. The irradiated UV ray 150 enters from a part of the TFT substrate 12 which corresponds to the sealant to cure the sealant 113. With the wiring 112 of Al or the like formed in the light shielding part of the TFT substrate 12, the UV ray 150 is intercepted by the wiring 112 to leave an uncured region 116 in the sealant 113. The UV ray 150 reaching the sealant 113, however, advances straight and reaches the UV ray reflection face 110 formed on the light shielding part of the CF substrate 51 to be irradiated to the sealant 113 again.

Wherein, the sealant 113 contains the particles 48 reflecting the UV ray 150, so that the UV ray 150 is reflected at the interface between the sealant 113 and the particles 48 reflecting the UV ray 150 to be scattered in a wide range. The thus scattered UV ray 150 is irradiated to the sealant 113 again and is reflected by the wiring 112 of Al or the like formed on the TFT substrate 12 to be irradiated all over a wide range of the sealant 113. Accordingly, the uncured region 116 of the sealant 113 is cured by the reflected UV ray.

Next, the light shielding mask 115 is removed, heating and heat removal are performed, and then, the substrates are cut into a desired panel frame.

In this way, the liquid crystal display panel 54 is formed in which the liquid crystal material 114 is sealed by the sealant 113 between the two substrates. Then, the back light unit and the like (not shown) are provided thereto to complete the liquid crystal display device 50.

### Embodiment 6

(Constructions of Color Filter Substrate 61 and Liquid Crystal Display Device 60 Using it)

FIG. 6 is a sectional view of a liquid crystal display device 60 in accordance with Embodiment 6. The same reference numerals are assigned to the same parts as those indicated in the above embodiment for omitting description thereof.

The liquid crystal display device 60 includes a liquid crystal display panel 64, the back light, and the like (not shown), wherein the liquid crystal display panel 64 includes the TFT substrate 12 and a CF substrate 61 opposed to each other and the liquid crystal layer 13 between the substrates.

In the CF substrate 61, the color layer 16 composing the display part and the counter electrode and the alignment film (both not shown) are formed on the glass substrate 15. The black matrix 17 is provided around the outer periphery of the color layer 16 to form the light shielding part. The UV ray reflection film 19 is formed on the black matrix 17, and a UV ray scattering layer 68 is formed on the UV ray reflection film 19.

The UV ray scattering layer 68 is made of a transparent material so as to allow a UV ray to transmit therethrough. The UV ray scattering layer 68 may be a UV ray scattering resin layer made of a resin material. The UV ray scattering layer 68 has a surface having refractivity different from that of the sealant 113 and formed in a bumpy shape or the like scattering the UV ray.

The sealant 113 is provided between the UV ray scattering layer 68 formed on the CF substrate 61 and the opposed TFT substrate 12 so as to bond the substrates to each other. The sealant 113 has no liquid crystal sealing port and is arranged continuously with no cut formed so as to surround the display part, thereby forming the liquid crystal display cell.

(Method for Manufacturing Liquid Crystal Display Device 60)

A method for manufacturing the liquid crystal display device 60 in accordance with Embodiment 6 will be described next. Description of the same parts as those indicated in the above embodiment is omitted.

(Process of for Manufacturing CF Substrate 61)

First, as in Embodiment 1, the color layer 16, the black matrix 17, the counter electrode, and the alignment film are formed on the glass substrate 15.

Next, the UV ray reflection film 19 and the UV ray scattering layer 68 are formed on the black matrix 17.

Through the above steps, the CF substrate 61 is completed.

(Process of Manufacturing TFT Substrate 12)

Subsequently, the TFT substrate 12 is formed by the same manner as in Embodiment 1.

(Process of Forming Liquid Crystal Display Panel 64)

Thereafter, the sealant 113 is applied continuously without forming a cut onto the light shielding part of the TFT substrate 12 in which the wiring 112 is formed.

Next, the liquid crystal material 114 is dropped within the frame-shaped sealant 113 applied around the outer periphery of the light shielding part of the TFT substrate 12 with the use of a dispenser or the like.

Subsequently, the CF substrate 61 is aligned and joined to the TFT substrate 12 on which the liquid crystal material 114 is dropped. This step is performed under a vacuum state. Then, the substrates are returned to the air so that the liquid crystal material 114 is dispersed by the air pressure.

Thereafter, the UV ray 150 is irradiated from the TFT substrate 12 side with the light shielding mask 115 formed on the display part of the TFT substrate 12. The irradiated UV ray 150 enters from a part of the TFT substrate 12 which corresponds to the sealant to cure the sealant 113. With the wiring 112 of Al or the like formed in the light shielding part of the TFT substrate 12, the UV ray 150 is intercepted by the wiring 112 to leave an uncured region 116 in the sealant 113. The UV ray 150 reaching the sealant 113, however, reaches and is reflected by the UV ray reflection face 110 formed in the light shielding part of the CF substrate 61 to reach the UV ray scattering layer 68 formed on the surface thereof, thereby being scattered.

The thus scattered and reflected UV ray 150 is irradiated again to the sealant 113 and is reflected also by the wiring 112 of Al or the like formed on the TFT substrate 12 so as to be irradiated all over a wide range of the sealant 113. Accordingly, the uncured region 116 of the sealant 113 is cured by the reflected UV ray.

Next, the light shielding mask 115 is removed, heating and heat removal are performed, and then, the substrates are cut into a desired panel frame.

In this way, the liquid crystal display panel 64 is formed in which the liquid crystal material 114 is sealed by the sealant 113 between the two substrates. Then, the back light unit and the like (not shown) are provided thereto to complete the liquid crystal display device 60.

### Embodiment 7

(Constructions of Color Filter Substrate 71 and Liquid Crystal Display Device 70 Using it)

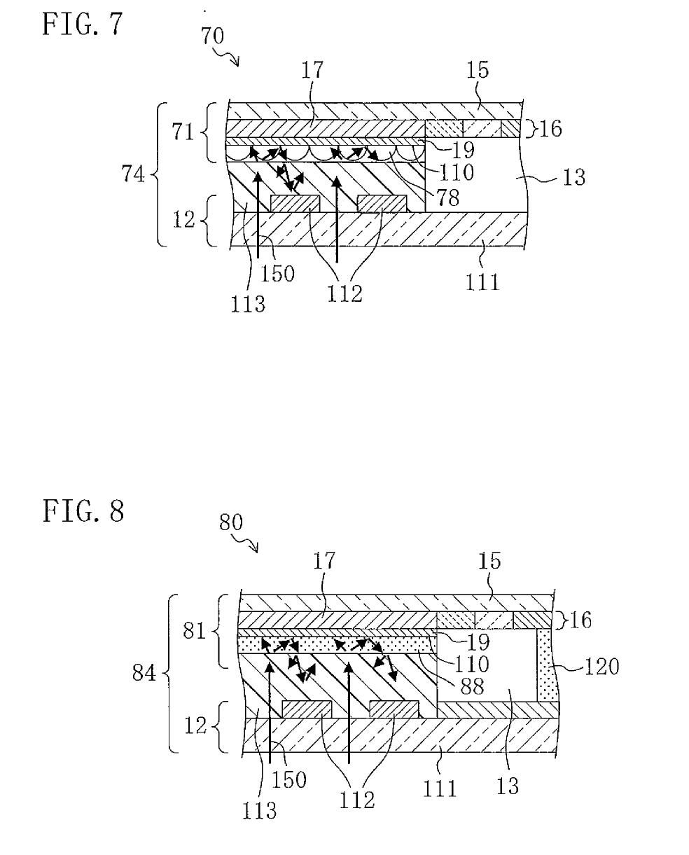

FIG. 7 is a sectional view of a liquid crystal display device 70 in accordance with Embodiment 7. The same reference numerals are assigned to the same parts as those indicated in the above embodiment for omitting description thereof.

The liquid crystal display device 70 includes a liquid crystal display panel 74, the back light, and the like (not shown), wherein the liquid crystal display panel 74 includes the TFT substrate 12 and a CF substrate 71 opposed to each other and the liquid crystal layer 13 between the substrates.

In the CF substrate 71, the color layer 16 composing the display part and the counter electrode and the alignment film (both not shown) are formed on the glass substrate 15. The black matrix 17 is provided around the outer periphery of the color layer 16 to form the light shielding part. The UV ray reflection film 19 is formed on the black matrix 17.

On the UV ray reflection film 19, a layer (a microlens layer 78) composed of a plurality of lenses is formed. The microlens layer 78 is made of a transparent material so as to allow a UV ray to transmit therethrough.

The sealant 113 is provided between the microlens layer 78 formed on the CF substrate 71 and the opposed TFT substrate 12 so as to bond the substrates to each other. The sealant 113 has no liquid crystal sealing port and is arranged continuously with no cut formed so as to surround the display part, thereby forming the liquid crystal display cell.

(Method for Manufacturing Liquid Crystal Display Device 70)

A method for manufacturing the liquid crystal display device 70 in accordance with Embodiment 7 will be described next. Description of the same parts as those indicated in the above embodiment is omitted.

(Process of Manufacturing CF Substrate 71)

First, as in Embodiment 1, the color layer 16, the black matrix 17, the counter electrode) and the alignment film are formed on the glass substrate 15.

Next, the UV ray reflection film 19 and the microlens layer 78 are formed on the black matrix 17.

Through the above steps, the CF substrate 71 is completed.

(Process of Manufacturing TFT Substrate 12)

Subsequently, the TFT substrate 12 is formed by the same manner as in Embodiment 1.

(Process of Forming Liquid Crystal Display Panel 74)

Thereafter, the sealant 113 is applied continuously without forming a cut onto the light shielding part of the TFT substrate 12 in which the wiring 112 is formed.

Next, the liquid crystal material 114 is dropped within the frame-shaped sealant 113 applied around the outer periphery of the light shielding part of the TFT substrate 12 with the use of a dispenser or the like.

Subsequently, the CF substrate 71 is aligned and joined to the TFT substrate 12 on which the liquid crystal material 114 is dropped. This step is performed under a vacuum state. Then, the substrates are returned to the air so that the liquid crystal material 114 is dispersed by the air pressure.

Thereafter, the UV ray 150 is irradiated from the TFT substrate 12 side with the light shielding mask 115 formed on the display part of the TFT substrate 12. The irradiated UV ray 150 enters from a part of the TFT substrate 12 which corresponds to the sealant to cure the sealant 113. With the wiring 112 of Al or the like formed in the light shielding part of the TFT substrate 12, the UV ray 150 is intercepted by the wiring 112 to leave an uncured region 116 in the sealant 113. The UV ray 150 reaching the sealant 113, however, reaches and is reflected by the UV ray reflection face 110 formed in the light shielding part of the CF substrate 71 to reach the microlens layer 78 formed on the surface thereof, thereby being scattered.

The thus scattered and reflected UV ray 150 is irradiated again to the sealant 113 and is reflected also by the wiring 112 of Al or the like formed on the TFT substrate 12 so as to be irradiated all over a wide range of the sealant 113. Accordingly, the uncured region 116 of the sealant 113 is cured by the reflected UV ray.

Next, the light shielding mask 115 is removed, heating and heat removal are performed, and then, the substrates are cut into a desired panel frame.

In this way, the liquid crystal display panel 74 is formed in which the liquid crystal material 114 is sealed by the sealant 113 between the two substrates. Then, the back light unit and the like (not shown) are provided thereto to complete the liquid crystal display device 70.

### Embodiment 8

(Constructions of Color Filter Substrate and Liquid Crystal Display Device 70 Using it)

FIG. 8 is a sectional view of a liquid crystal display device 80 in accordance with Embodiment 8. The same reference numerals are assigned to the same parts as those indicated in the above embodiment for omitting description thereof.

The liquid crystal display device 80 includes a liquid crystal display panel 84, the back light, and the like (not shown), wherein the liquid crystal display panel 84 includes the TFT substrate 12 and a CF substrate 81 opposed to each other and the liquid crystal layer 13 between the substrates.

In the CF substrate 81, the color layer 16 composing the display part, the counter electrode and the alignment film (both not shown), and column-shaped spacers 120 are formed on the glass substrate 15. The black matrix 17 is provided around the outer periphery of the color layer 16 to form the light shielding part. The UV ray reflection film 19 is formed on the black matrix 17, and a UV ray scattering layer 88 is formed on the UV ray reflection film 19.

The UV ray scattering layer 88 is made of a transparent material so as to allow a UV ray to transmit therethrough. The column-shaped spacers 120 are made of the same transparent material, as well. The UV ray scattering layer 88 has a surface formed into a bumpy shape or the like scattering the UV ray.

The sealant 113 is provided between the UV ray scattering layer 88 formed on the CF substrate 71 and the opposed TFT substrate 12 so as to bond the substrates to each other. The sealant 113 has no liquid crystal sealing port and is arranged continuously with no cut formed so as to surround the display part, thereby forming the liquid crystal display cell.

(Method for Manufacturing Liquid Crystal Display Device 80)

A method for manufacturing the liquid crystal display device 80 in accordance with Embodiment 8 will be described next. Description of the same parts as those indicated in the above embodiment is omitted.

(Process of Manufacturing CF Substrate 81)

First, the color layer 16, the black matrix 17, the counter electrode, and the alignment film are formed on the glass substrate 15. The UV ray reflection film 19 is formed on the black matrix 17 in this time point.

Next, the column-shaped spacers 120 and the UV ray scattering layer 88 are formed with the use of the same material in the same step.

Through the above steps, the CF substrate 81 is completed.

(Process of Manufacturing TFT Substrate 12)

Subsequently, the TFT substrate 12 is formed by the same manner as in Embodiment 1. Additional column-shaped spacers may be formed on the TFT substrate 12 in this time point.

(Process of Forming Liquid Crystal Display Panel 84)

Thereafter, the sealant 113 is applied continuously without forming a cut onto the light shielding part of the TFT substrate 12 in which the wiring 112 of Al or the like is formed.

Next, the liquid crystal material 114 is dropped within the frame-shaped sealant 113 applied around the outer periphery of the light shielding part of the TFT substrate 12.

Subsequently, the CF substrate 81 is aligned and joined to the TFT substrate 12 on which the liquid crystal material 114 is dropped. This step is performed under a vacuum state. Then, the substrates are returned to the air so that the liquid crystal material 114 is dispersed by the air pressure.

Subsequently, as in Embodiment 6, the sealant 113 is cured by the UV ray 150, and then, the liquid crystal display device 80 is completed.

In Embodiment 8, the same structure (the UV ray scattering layer 88) as in Embodiment 6 (the UV ray scattering layer 68) is used as the UV ray scattering means, but the UV ray scattering means is not limited thereto and may have the same structure as that in Embodiment 1 or 2. In any of these cases, the UV ray scattering means and the column-shaped spacers 120 can be formed with the use of the same material in the same step.

### Embodiment 9

(Structures of Color Filter Substrate 91 and Liquid Crystal Display Device 90 Using it)

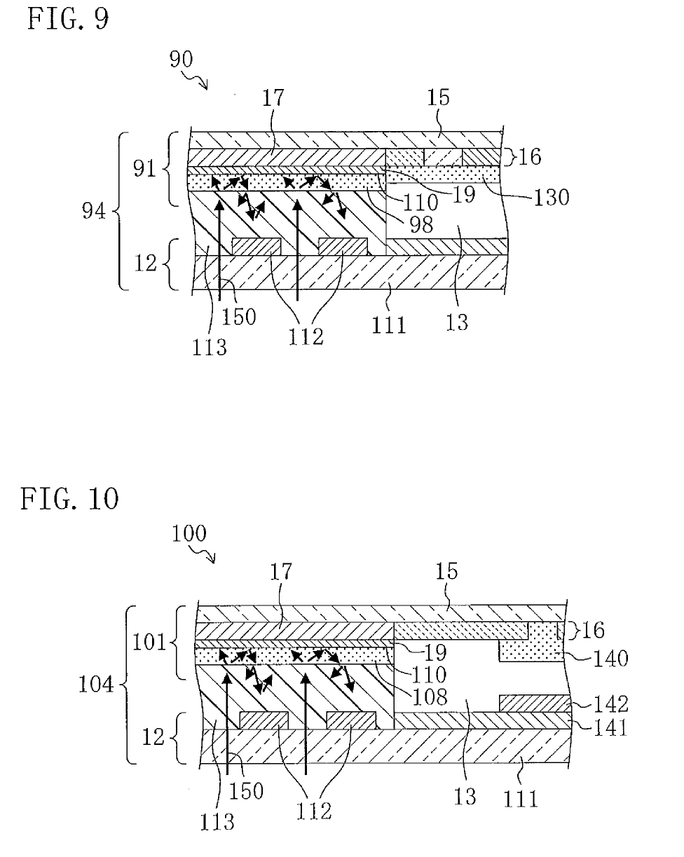

FIG. 9 is a sectional view of a liquid crystal display device 90 in accordance with Embodiment 9. The same reference numerals are assigned to the same parts as those indicated in the above embodiment for omitting description thereof.

The liquid crystal display device 90 includes a liquid crystal display panel 94, the back light, and the like (not shown), wherein the liquid crystal display panel 94 includes the TFT substrate 12 and a CF substrate 91 opposed to each other and the liquid crystal layer 13 between the substrates.

In the CF substrate 91, the color layer 16 composing the display part, an overcoat layer 130, and the counter electrode and the alignment film (both not shown) are formed on the glass substrate 15. The black matrix 17 is provided around the outer periphery of the color layer 16 to form the light shielding part. The UV ray reflection film 19 is formed on the black matrix 17, and a UV ray scattering layer 98 is formed on the UV ray reflection film 19.

The UV ray scattering layer 98 is made of a transparent material so as to allow a UV ray to transmit therethrough. The overcoat layer 130 is made of the same transparent material.

The sealant 113 is provided between the UV ray scattering layer 98 formed on the CF substrate 91 and the opposed TFT substrate 12 so as to bond the substrates to each other. The sealant 113 has no liquid crystal sealing port and is arranged continuously with no cut formed so as to surround the display part, thereby forming the liquid crystal display cell.

(Method for Manufacturing Liquid Crystal Display Device 90)

A method for manufacturing the liquid crystal display device 90 in accordance with Embodiment 9 will be described next. Description of the same parts as those indicated in the above embodiment is omitted.

(Process of Manufacturing CF Substrate 91)

First, the color layer 16 and the black matrix 17 are formed on the glass substrate 15. The UV ray reflection film 19 is formed on the black matrix 17 in this time point. Next, the overcoat layer 130 and the UV ray scattering layer 98 are formed on the color layer 16 and the black matrix 17, respectively, with the use of the same material in the same step.

Subsequently, the counter electrode and the alignment film are formed on the overcoat layer 130.

Through the above steps, the CF substrate 91 is completed.

(Process of Manufacturing TFT Substrate 12)

Subsequently, the TFT substrate 12 is formed by the same manner as in Embodiment 1.

(Process of Forming Liquid Crystal Display Panel 94)

Thereafter, the sealant 113 is applied continuously without forming a cut onto the light shielding part of the TFT substrate 12 in which the wiring 112 is formed.

Next, the liquid crystal material 114 is dropped within the frame-shaped sealant 113 applied around the outer periphery of the light shielding part of the TFT substrate 12.

Subsequently, the CF substrate 91 is aligned and joined to the TFT substrate 12 on which the liquid crystal material 114 is dropped. This step is performed under a vacuum state. Then, the substrates are returned to the air so that the liquid crystal material 114 is dispersed by the air pressure.

Thereafter, as in Embodiment 6, the sealant 113 is cured by the UV ray 150, and the liquid crystal display layer 90 is completed.

In Embodiment 9, the same structure (the UV ray scattering layer 98) as in Embodiment 6 (the UV ray scattering layer 68) is used as the UV ray scattering means, but the UV ray scattering means is not limited thereto and may have the same structure as that in Embodiment 1 or 2. In any of these cases, the UV ray scattering means and the overcoat layer 130 can be formed with the use of the same material in the same step.

### Embodiment 10

(Constructions of Color Filter Substrate 101 and Liquid Crystal Display Device 100 Using it)

FIG. 10 is a sectional view of a liquid crystal display device 100 in accordance with Embodiment 10. The liquid crystal display device 100 is of transflective type capable of performing both transmissive mode display and reflective mode display.

The liquid crystal display device 100 includes a liquid crystal display panel 104, the back light, and the like (not shown), wherein the liquid crystal display panel 104 includes the TFT substrate 12 and a CF substrate 101 opposed to each other and the liquid crystal layer 13 between the substrates.

The CF substrate 101 includes the glass substrate 15, the color layer 16 and the black matrix 17 which are formed on the glass substrate 15, the counter electrode (not shown), a step layer, and the alignment film (not shown). The black matrix 17 is provided around the outer periphery of the color layer 16 to form the light shielding part. The step layer 140, which has a predetermined thickness, is formed in a region of the CF substrate 101 which is to be a reflection region. The thickness of the step layer 140 is preferably approximately half of the thickens of the liquid crystal layer 13. Light for display passes through the liquid crystal layer 13 twice in the reflective mode display while passing through the liquid crystal layer 13 only one time in the transmissive mode display. Accordingly, when the thickness of a light transmissive display part of the liquid crystal layer 13 is set approximately the double of the thickness of a light reflective display part of the liquid crystal layer 13, the light paths become the same in length to achieve favorable display in both display modes.

The UV ray reflection film 19 and a UV ray scattering layer 108 are formed on the black matrix 17.

In the TFT substrate 12, the TFT elements (not shown) and pixel electrodes 141 are formed on the glass substrate 111 to form the display part. A reflection layer 142 formed of a bumpy resin layer and Al film or an Al containing metal film is formed in a region of the display part which is to be the reflection region, and a transparent insulating layer (not shown) is formed so as to cover the reflection layer 142 to flatten the bumpy surface of the reflection layer 142. The alignment film is formed on the flat surface of the transparent insulating layer.

The sealant 113 is provided between the UV ray scattering layer 108 formed on the CF substrate 101 and the opposed TFT substrate 12 so as to bond the substrates to each other. The sealant 113 has no liquid crystal sealing port and is arranged continuously with no cut formed so as to surround the display part, thereby forming the liquid crystal display cell.

(Method for Manufacturing Liquid Crystal Display Device 100)

A method for manufacturing the liquid crystal display device 100 in accordance with Embodiment 10 will be described next. Description of the same parts as those indicated in the above embodiment is omitted.

(Process of Manufacturing CF Substrate 101)

First, the color layer 16, the black matrix 17, and the counter electrode are formed on the glass substrate 15. The UV ray reflection film 19 is formed on the black matrix 17 in this time point.

Next, the step layer 140 and the UV ray scattering layer 108 are formed with the use of the same material in the same step, and then, the alignment film are formed on the counter electrode and the step layer 140.

Through the above steps, the CF substrate 101 is completed.

(Process of Manufacturing TFT Substrate 12)

Subsequently, the TFT substrate 12 is formed by the same manner as in Embodiment 1.

(Process of Forming Liquid Crystal Display Panel 104)

Thereafter, the sealant 113 is applied continuously without forming a cut onto the light shielding part of the TFT substrate 12 in which the wiring 112 of Al or the like is formed.

Next, the liquid crystal material 114 is dropped within the frame-shaped sealant 113 applied around the outer periphery of the light shielding part of the TFT substrate 12.

Subsequently, the CF substrate 101 is aligned and joined to the TFT substrate 12 on which the liquid crystal material 114 is dropped. This step is performed under a vacuum state. Then, the substrates are returned to the air so that the liquid crystal material 114 is dispersed by the air pressure.

Next, as in Embodiment 6, the sealant 113 is cured by the UV ray 150, and the liquid crystal display device 100 is completed.

In Embodiment 10, the same structure (the UV ray scattering layer 108) as in Embodiment 6 (the UV ray scattering layer 68) is used as the UV ray scattering means, but the UV ray scattering means is not limited thereto and may have the same structure as that in Embodiment 1 or 2. In any of these cases, the UV ray scattering means and the step layer 140 can be formed with the use of the same material in the same step.

The liquid crystal display panels 14 to 104 may not be formed as in the present embodiment. Alternatively, the liquid crystal display panels 14 to 104 may be formed in such a manner that a liquid crystal injection port is formed at the side of the liquid crystal display panel bonded by a UV curable resin; the liquid crystal material is injected therethrough; and the liquid crystal injection port is then sealed by a UV curable resin.

In addition, the present embodiments refer to a color filter substrate and a display device using it for LCD (liquid crystal display), but the present invention may be applied to a substrate and a display device using it for any of PD (plasma display), PALC (plasma addressed liquid crystal display), organic EL (organic electroluminescence), inorganic EL (inorganic electroluminescence), FED (field emission display), and SED (surface-conduction electron-emitter display).

(Effects)

Obtainable effects will be discussed next.

A display device 10 to 100 in accordance with any of Embodiments 1 to 10 includes: a CF substrate 11 to 101 and a TFT substrate 12 opposed to each other and a liquid crystal layer 13 interposed therebetween, wherein the liquid crystal layer 13 has an outer peripheral part sealed by a sealant 113 of UV curable resin provided between the CF substrate 11 to 101 and the TFT substrate 12, the CF substrate 11 to 101 includes a light shielding part including a black matrix 17 provided at a part corresponding to the sealant 113 while the TFT substrate 12 includes a transparent part provided at a part corresponding to the sealant 113, and the light shielding part has a UV ray reflection face 110 on a sealant 113 side thereof.

In the above arrangement in the display device provided with the sealant 113 made of the UV curable resin formed in the light shielding part in which the black matrix 17 is provided, the CF substrate 11 to 101 and the TFT substrate 12 are bonded to each other by UV ray irradiation. To do so, the sealant 113 is irradiated with the UV ray from the transparent sealant corresponding part of the TFT substrate 12 for curing the sealant 13, wherein the UV ray irradiated from the TFT substrate 12 side is reflected by the UV reflection face 110 formed on the light shielding part of the CF substrate 11 to 101 to the sealant 113 to irradiate the sealant 113 again. Accordingly, even if a wiring of Al or the like is formed on the substrate to inhibit the UV ray from reaching the sealant 113, the UV ray is irradiated to the sealant 113 again from the UV ray reflection face 110 to cure an uncured part of the sealant 113. Thus, ordinary UV ray irradiation cures the sealant 113 further effectively and easily.

In the display device 10 to 110 in accordance with the present embodiment, the UV ray reflection face 110 may be made of Al or Ag.

With the above arrangement, Al or Ag of the UV ray reflection face 110 increases the reflectivity of the UV ray reflection face 110, thereby achieving further efficient and easy UV ray reflection to cure the sealant 113.

Further, in the display device 20 in accordance with the present embodiment, the UV ray reflection face may be so composed to receive a UV ray and reflect the UV ray outward of the liquid crystal layer 13.

With the above arrangement, entering of the UV ray reflected by the UV ray reflection face 110 into the liquid crystal layer 13 is suppressed. Accordingly, adverse influence on display quality, which is caused due to influence of the UV ray on the liquid crystal, can be suppressed.

The display device 10 to 100 in accordance with the present embodiment may further includes UV ray scattering means 18 to 108 scattering a UV ray reflected by the UV ray reflection face 110.

With the above arrangement, the UV ray reflected by the UV ray reflection face 110 is scattered by the UV ray scattering means 18 to 108 to attain more effective irradiation of a part of the sealant 113 which is light-shielded and remains uncured with the UV ray. Thus, the entire region of the sealant 113 can be cured effectively and easily.

In the display device 10 to 30 in accordance with the present embodiment, the UV ray scattering means may be a bumpy part formed in the light shielding part, wherein the UV ray reflection face 110 is formed on the bumpy part.

In the above arrangement, the UV ray scattering means is the bumpy part formed in the light shielding part and the UV ray reflection face 110 is formed on the bumpy part. Accordingly, the UV ray reaching the UV ray reflection face 110 is scattered correspondingly to the bumpy part upon reflection. Thus, the entire region of the sealant 113 can be cured further effectively and easily.

In the liquid crystal display device 30 in accordance with the present embodiment, the bumpy part may be the black matrix 17 of the light shielding part.

With the above arrangement, formation of the black matrix 17 of the light shielding part as the bumpy part eliminates the need to prepare another member for forming the bumpy part. In other words, only required is to form the black matrix 17 so as to have the bumpy part. Accordingly, the UV ray scattering means can be formed efficiently.

Furthermore, in the display device 40, 50 in accordance with the present embodiment, the UV ray scattering means may be composed of UV ray scattering particles 48, 58 contained in the sealant 113.

In the above arrangement, the UV ray scattering particles 48, 58 are contained in the sealant 113 in advance to enable provision of the UV ray scattering means by supplying the sealant 113 to the substrate at the same time. Accordingly, the manufacturing efficiency increases. Further, when the sealant 113 contains the UV ray scattering particles 48, 58, the UV ray scattering means spreads uniformly in the sealant 113, thereby attaining further effective scattering of the UV ray.

In the display device 40 in accordance with the present embodiment, the UV ray scattering particles 48 may have a refractivity different from the sealant 113.

In the above arrangement, the UV ray scattering particles 48 have a refractivity different from the sealant 113, so that the IV ray is refracted at the interface between the sealant 113 and the UV ray scattering particles, thereby being scattered effectively over the entire sealant 113.

Furthermore, in the display device 50 in accordance with the present embodiment, the UV ray scattering particles 58 may reflect a UV ray.

In the above arrangement, the UV ray scattering particles 58 reflects the UV ray, and accordingly, the UV ray is scattered by the UV ray scattering particles 58 effectively to the entire sealant 113.

In the display device 60 to 100 in accordance with the present embodiment, the UV ray reflection face 110 and the UV ray scattering means 68 to 108 may be formed in this order on the black matrix 17.

In the above arrangement, the UV ray reflection face 110 and the UV ray scattering means 68 to 108 are provided in this order on the black matrix 17. Accordingly, the UV ray is reflected by the UV ray reflection face 110 and then is scattered by the UV ray scattering means 68 to 108. This allows the UV ray to reach the entire sealant 113 thoroughly, thereby curing the sealant 113 effectively.

In the display device 60, 80 to 100 in accordance with the present embodiment, the UV ray scattering means may be a UV ray scattering resin layer 68, 88 to 108

In the above arrangement, the UV ray scattering means is the UV ray scattering resin layer 68, 88 to 108, and therefore, the UV ray scattering means can be formed into a desired shape easily. Accordingly, the UV ray can be scattered easily in the entire sealant 113 or a desired part selectively.

Still further, in the display device 70 in accordance with the present embodiment, the UV ray scattering means may be a bumpy layer 78 having a refractivity different from that of the sealant 113.

In the above arrangement, the UV ray scattering means is the bumpy layer 78 having a refractivity different from that of the sealant 113. Accordingly, the reflected UV ray is refracted at the interface between the sealant 113 and the bumpy layer 78 to reach the entire sealant 113 thoroughly, thereby curing the sealant 113 effectively.

In the display device 70 in accordance with the present embodiment, the UV ray scattering means may be a layer 78 formed of a plurality of lenses.

In the above arrangement, the UV ray scattering means is a layer 78 formed of a plurality of lenses, which means attainment of the UV ray scattering means having a simple structure.

In the display device 80 in accordance with the present embodiment, a column-shaped spacer 120 may be provided between the CF substrate 101 and the TFT substrate 12, wherein the column-shaped spacer 120 is made of the same material as the UV ray scattering means.

In the above arrangement, the column-shaped spacer 120 made of the same material as that of the UV ray scattering means 88 is provided between the CF substrate 101 and the TFT substrate 12. This enables formation of the column-shaped spacer 120 and the UV ray scattering means 88 with the use of the same material in the same step, thereby increasing the production efficiency of the device.

In the display device 90 in accordance with the present embodiment, the display part may include a display element covered with an overcoat layer 130, wherein the overcoat layer 130 is made of the same material as the UV ray scattering means 98.

In the above arrangement, the display element of the display part is covered with the overcoat layer 130 made of the same material as that of the UV ray scattering means 98. Accordingly, the overcoat layer 130 and the UV ray scattering means 98 can be formed with the use of the same material in the same step, thereby increasing the production efficiency of the device.

In addition, in the display device 100 in accordance with the present embodiment, the display part may be composed of a light reflection region provided with a step layer 140 for restricting a gap between the CF substrate 101 and the TFT substrate 12 and a light transmission region, wherein the step layer 140 formed in the light reflection region is made of the same material as the UV ray scattering means 108.

In the above arrangement, the display part is formed of the light transmitting region and the light reflection region in which the step layer 140 is formed for restricting the gap between the CF substrate 101 and the TFT substrate 12, and the step layer 140 formed in the light reflection region is made of the same material as the UV ray scattering means. Accordingly, the step layer 140 formed in the light reflection region and the UV ray scattering means 108 can be formed with the use of the same material in the same step, thereby increasing the production efficiency of the device.

A display device 10 to 100 manufacturing method in accordance with the present embodiment is a method including the steps of: preparing a CF substrate 11 to 101 and a TFT substrate 12 each including a display cell formation part; forming a black matrix 17 on the CF substrate 11 to 101 so as to surround and enclose the display cell formation part of the CF substrate 11 to 101; providing a UV ray reflection face 110 on the black matrix 17 formed on the CF substrate 11 to 101; providing a sealant 113 at a light shielding part formation part of the CF substrate 11 to 101 or the TFT substrate 12 without forming a cut; supplying a liquid crystal material 114 to the display cell formation part of the CF substrate 11 to 101 or the TFT substrate 12 to which the sealant 113 is provided; bonding the CF substrate 11 to 101 or the TFT substrate 12 to which the liquid crystal material 114 is supplied to the other substrate; and obtaining bonded substrates by curing the sealant 113 by irradiating the sealant 113 with a UV ray from the surface of the bonded TFT substrate 12.

According to the above arrangement, for manufacturing a display device in which the sealant 113 made of the UV curable resin is formed in the light shielding part in which the black matrix 17 is provided, the CF substrate 10 to 101 and the TFT substrate 12 are bonded to each other by curing the sealant 113 by UV ray irradiation. In the UV ray irradiation, the UV ray irradiated from the TFT substrate 12 side is reflected to the sealant 113 by the UV ray reflection face 110 formed in the light shielding part of the CF substrate 11 to 101, thereby being irradiated to the sealant 113 again. Accordingly, even if a wiring of Al or the like is formed on the substrate to inhibit the UV ray from reaching the sealant 113, the sealant 113 is irradiated again with the UV ray from the UV ray reflection face 110, thereby curing an uncured part of the sealant 113. Thus, ordinary UV ray irradiation cures the sealant 113 further effectively and easily.

A color filter substrate 11 to 101 in accordance with the present embodiment includes: a glass substrate 15 including a display part; a black matrix 17 provided along an outer periphery of the display part of the glass substrate 15 and forming a light shielding part; and a UV ray reflection face 110 provided on the black matrix 17 on the glass substrate 15.

With the above arrangement, the following advantages can be attained in a display device in which the sealant 113 made of the UV curable resin is formed in the light shielding part in which the black matrix 17 is provided. Namely: for bonding the color CF substrate 11 to 101 and the TFT substrate 12 to each other by UV ray irradiation, the UV ray is irradiated at the part of the TFT substrate 12 which corresponds to the sealant to cure the sealant 113; the UV ray irradiated from the TFT substrate 12 side is reflected to the sealant 113 by the UV ray reflection face 110 formed in the light shielding part of the color filter substrate 11 to 101 to thus irradiate the sealant 113 again. Accordingly, even if a wiring of Al or the like is formed on the TFT substrate 12 to inhibit the UV ray from reaching the sealant 113, the sealant 113 is irradiated again with the UV ray from the UV ray reflection face 110, thereby curing an uncured part of the sealant 113. Thus, ordinary UV ray irradiation cures the sealant 113 further effectively and easily.

### INDUSTRIAL APPLICABILITY

As described above, the present invention is useful for display devices, display device manufacturing methods, substrates, and color filter substrates.

1. A display device comprising: first and second substrates opposed to each other and a display medium layer interposed therebetween,
wherein the display medium layer has an outer peripheral part sealed by a sealant of UV curable resin provided between the first and second substrates,
the first substrate includes a light shielding part including a light shielding layer provided at a part corresponding to the sealant while the second substrate includes a transparent part provided at a part corresponding to the sealant, and
the light shielding part has a UV ray reflection face on a sealant side thereof.

2. The display device of claim 1,
wherein the UV ray reflection face is made of Al or Ag.

3. The display device of claim 1,
wherein the UV ray reflection face receives a UV ray and reflects the UV ray outward of the display medium layer.

4. The display device of claim 1, further comprising
UV ray scattering means scattering a UV ray reflected by the UV ray reflection face.

5. The display device of claim 4,
wherein the UV ray scattering means is a bumpy part formed in the light shielding part, and the UV ray reflection face is formed on the bumpy part.

6. The display device of claim 5,
wherein the bumpy part is the light shielding layer of the light shielding part.

7. The display device of claim 4,
wherein the UV ray scattering means is composed of UV ray scattering particles contained in the sealant.

8. The display device of claim 7,
wherein the UV ray scattering particles has a refractivity different from the sealant.

9. The display device of claim 7,
wherein the UV ray scattering particles reflect a UV ray.

10. The display device of claim 4,
wherein the UV ray reflection face and the UV ray scattering means are formed in this order on the light shielding layer.

11. The display device of claim 10,
wherein the UV ray scattering means is a UV ray scattering resin layer.

12. The display device of claim 10,
wherein the UV ray scattering means is a bumpy layer having a refractivity different from that of the sealant.

13. The display device of claim 12,
wherein the UV ray scattering means is a layer formed of a plurality of lenses.

14. The display device of claim 4,
wherein a spacer is provided between the first and second substrates, and
the spacer is made of the same material as the UV ray scattering means.

15. The display device of claim 4,
wherein the display part includes a display element covered with an overcoat layer, and
the overcoat layer is made of the same material as the UV ray scattering means.

16. The display device of claim 4,
wherein the display part is composed of a light reflection region provided with a step layer for restricting a gap between the first substrate and the second substrate and a light transmission region, and
the step layer formed in the light reflection region is made of the same material as the UV ray scattering means.

17. A display device manufacturing method comprising the steps of:
preparing a first and second substrates each including a display cell formation part;
forming a light shielding layer on the first substrate so as to surround and enclose the display cell formation part of the first substrate;
providing a UV ray reflection face on the light shielding layer formed on the first substrate;
providing a sealant at a light shielding part formation part of the first or second substrate without forming a cut;
supplying a display medium to the display cell formation part of the first or second substrate to which the sealant is provided;
bonding the first or second substrate to which the display medium is supplied to the other substrate; and
obtaining bonded substrates by curing the sealant by irradiating the sealant with a UV ray from the surface of the bonded second substrate.

18. A substrate comprising:
a transparent substrate including a display part;
a light shielding layer provided along an outer periphery of the display part of the transparent substrate and forming a light shielding part; and
a UV ray reflection face provided on the light shielding layer on the transparent substrate.

19. A color filter substrate comprising:
a substrate according to claim 18; and
a color filter.
